(19) United States
(12) Patent Application Publication
(10) Pub. No.: US 2015/0233523 A1
(43) Pub. Date: Aug. 20, 2015

(54) Systems and Devices for Equipment Storage

(71) Applicant: Frank Brown, Marysville, WA (US)

(72) Inventor: Frank Brown, Marysville, WA (US)

(21) Appl. No.: 14/184,557

(22) Filed: Feb. 19, 2014

(51) Int. Cl. F16M 13/02

(52) U.S. Cl. CPC F16M 13/022

(57) ABSTRACT

The present disclosure is directed to mounting clamps for selectively mounting a storage accessory to a rod, the mounting clamps including: a first clamp partner having a first body and a first rod-abutting face, a second clamp partner having a second body and a second rod-abutting face, a coupling mechanism for coupling the first clamp partner to the second clamp partner, and a universal connector having a universal connector attachment mechanism, the universal connector being attachable to the first clamp partner via the universal connector attachment mechanism. The first clamp partner and the second clamp partner are configured to be selectively coupled together to retain a rod, each of the first rod-abutting face and the second rod-abutting face making surface-to-surface contact with an outer surface of the rod. Further, at least one accessory device is attachable to the universal connector via a storage accessory attachment mechanism.

### BACKGROUND

The present disclosure relates generally to equipment retaining, storing, and/or organizing devices. In particular, equipment retaining, storing, and/or organizing devices for clamping to a rod of a boat are described.

Known equipment retaining, storing, and/or organizing devices for boats are not entirely satisfactory for the range of applications in which they are employed. For example, existing equipment retaining, storing, and/or organizing devices are often permanently installed on a boat, such as being installed in a wall of a boat. This type of installation requires drilling into a boat wall, which can weaken the overall integrity of the boat wall. Further, installation can require a lengthy amount of time and the operation of power tools. Thus, installation is particularly difficult to perform when the boat is out on the water.

In addition, conventional equipment retaining, storing, and/or organizing devices are not moveable, and therefore cannot be relocated to a more convenient location depending on the current desired operation and/or use of the boat. For example, if there is an increased number of passengers on a boat, it may be desirable to move an accessory retaining, storing, and/or organizing device to a location that is remote relative to a location where passengers are congregated (e.g., the main deck). In another example, if there is a decreased number of passengers on the boat, it may be desirable to move an accessory retaining and/or organizing device to a location where equipment is more easily accessible (e.g., the main deck).

Moreover, conventional equipment retaining, storing, and/or organizing devices are not interchangeable with other equipment retaining, storing, and/or organizing devices, and therefore cannot be changed depending on the current desired operation and/or use of the boat. For example, in one instance, an operator of the boat may be taking a fishing trip and require fishing equipment retaining, storing, and/or organizing devices. In a second instance, the operator may be taking a leisure trip and require other equipment retaining, storing, and/or organizing devices, such as cup holders or a flag holder.

Thus, there exists a need for equipment retaining, storing, and/or organizing systems and devices for boats that improve upon and advance the design of known systems and devices. Examples of new and useful equipment retaining, storing, and/or organizing systems and devices relevant to the needs existing in the field are discussed below.

### SUMMARY

The present disclosure is directed to a mounting clamp for selectively mounting a storage accessory to a rod, the mounting clamp including: a first clamp partner having a first body and a first rod-abutting face, a second clamp partner having a second body and a second rod-abutting face, a coupling mechanism for coupling the first clamp partner to the second clamp partner, and a universal connector having a universal connector attachment mechanism, the universal connector being attachable to the first clamp partner via the universal connector attachment mechanism. The first clamp partner and the second clamp partner are configured to be selectively coupled together to retain a rod, each of the first rod-abutting face and the second rod-abutting face making surface-to-surface contact with an outer surface of the rod. Further, at least one accessory device is attachable to the universal connector via a storage accessory attachment mechanism.

### BRIEF DESCRIPTION OF THE DRAWINGS

FIG. 1 is a perspective view of a first example device for clamping to a rod of a boat having an attachable accessory for retaining and/or organizing equipment.

FIG. 2 is an exploded view of the first example device for clamping to a rod of a boat shown in FIG. 1.

FIGS. 3A-3E are top plan, side plan, front plan, front perspective, and rear perspective views, respectively, of a first clamp partner for the first example device for clamping to a rod of a boat of FIG. 1.

FIGS. 4A-4E are top plan, side plan, front plan, front perspective, and rear perspective views, respectively, of a first clamp partner for the first example device for clamping to a rod of a boat of FIG. 1.

FIGS. 5A-5E are top plan, front plan, side plan, front perspective, and rear perspective views, respectively, of a universal connector for the first example of an equipment retaining and/or organizing device of FIG. 1.

FIGS. 6A-6D are top plan, side plan, front plan, and front perspective views, respectively, of an equipment retaining and/or organizing accessory of the first example of an equipment retaining and/or organizing device of FIG. 1.

FIG. 7 is a perspective view of a second example device for clamping to a rod of a boat having an attachable accessory for retaining and/or organizing equipment including an alternative equipment retaining and/or organizing accessory.

FIGS. 8A-8E are rear plan, top plan, front plan, front perspective, and rear perspective views, respectively, of a universal connector for the second example of an equipment retaining and/or organizing device of FIG. 7.

FIGS. 9A-9D are top plan, rear plan, side plan, and rear perspective views, respectively of the alternative equipment retaining and/or organizing accessory for the second example of an equipment retaining and/or organizing device of FIG. 7.

### DETAILED DESCRIPTION

The disclosed systems and devices having an attachable accessory for retaining, storing, and/or organizing equipment on a boat will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various systems and devices having an attachable accessory for retaining, storing, and/or organizing equipment on a boat are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

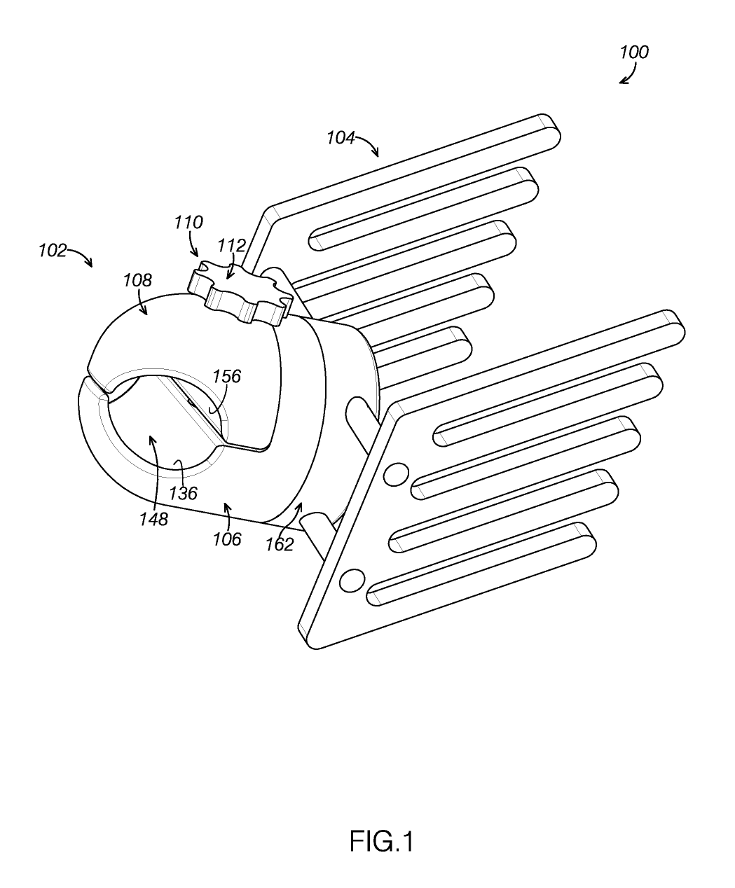

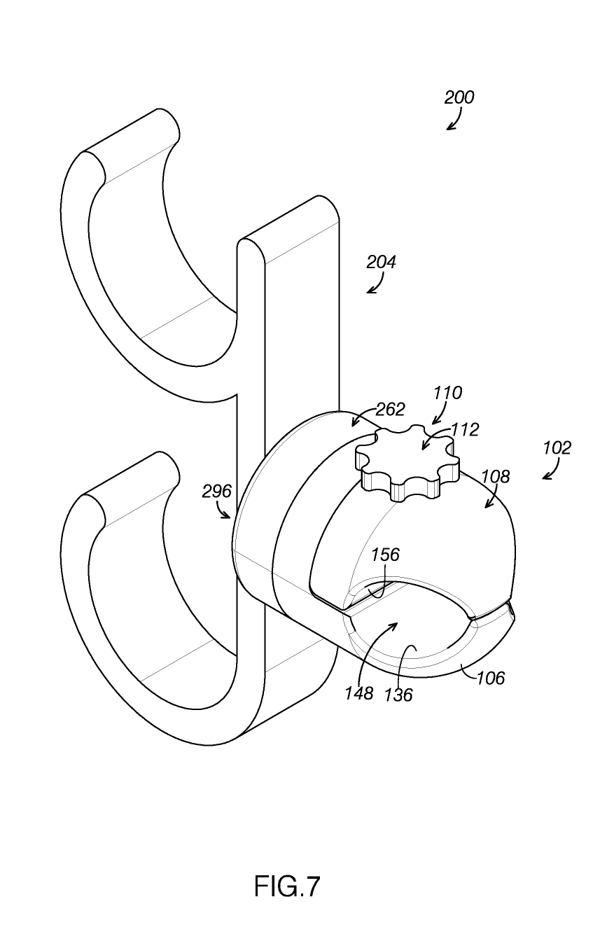

FIGS. 1-6D show a first example equipment storage device 100, while FIGS. 7-9D show a second example equipment storage device 200. Each of these equipment storage devices includes a clamping mechanism (102) for clamping onto a rod of a boat and an accessory for retaining, storing, and/or organizing equipment (104/204). More specifically, storage device 100 can be used for retaining, storing, and/or organizing fishing flashers, and storage device 200 can be used for retaining, storing, and/or organizing various pieces of equipment that can be retained, stored, or organized via hanging on a hook. Each of the storage devices can be selectively unclamped from a rod of the boat and be removed and/or moved to a different location. In some example systems, each of these storage devices can be used individually. In other example systems, the accessories can be interchangeably used with the same clamping mechanism. In even other example systems, the accessories can be interchangeably used with other accessories and other clamping mechanisms.

The systems and devices described herein for retaining, storing, and/or organizing equipment on a boat are adaptable to different situations and uses that may be desirable for the various uses of a boat. For example, if there is an increased number of passengers on a boat, a user can move an accessory retaining, storing, and/or organizing device to a location that is remote relative to a location where passengers are congregated (e.g., the main deck). In another example, if there is a decreased number of passengers on the boat, a user can move an accessory retaining and/or organizing device to a location where equipment is more easily accessible (e.g., the main deck).

In yet another example, a user can take a fishing trip and attach devices for retaining, storing, and/or organizing fishing equipment to rods of a boat. Additionally or alternatively, the user can take a leisure trip and attach other devices for retaining, storing, and/or organizing equipment to rods of the boat, such as cup holders and/or a flag holder. Thus, the presently described systems and devices for retaining, storing, and/or organizing equipment on a boat address many of the issues with conventional systems and devices described above.

With reference to FIGS. 1-6D, the first example of an equipment storage device, equipment storage device 100, will now be described. Equipment storage device 100 includes a rod clamping mechanism 102 and a storage accessory 104. Equipment storage device 100 functions to releasably attach to a rod and/or hand railing of boat for retaining, storing, and/or organizing equipment. More specifically, because of the configuration of storage accessory 104 (described in detail below), equipment storage device 100 can be used to retain, store, and/or organize one or more trolling flashers.

Rod clamping mechanism 102 includes a first clamp partner 106 selectively coupled to second clamp partner 108 via a clamp coupling mechanism 110. Clamp coupling mechanism 110 includes a clamp fastening member 112 that is selectively insertable into a vertical insertion hole 114 in second clamp partner 108 and a vertical insertion hole 116 in first clamp partner 106.

In the present example, clamp fastening member 112 is a threaded fastening member and insertion holes 114 and 116 are complimentarily configured to receive the threaded fastening member. In alternate examples, the fastening member and the insertion holes may have some other complimentary configuration for coupling of the first clamp member to the second clamp member, such as a releasable snap-fit mechanism. In even other examples, the clamp coupling mechanism may have some other configuration for coupling of the second clamp partner to the first clamp partner, such as a lever operated clamping coupling mechanism (i.e., a fastening member including lever operation for tightening and loosening the clamping coupling mechanism).

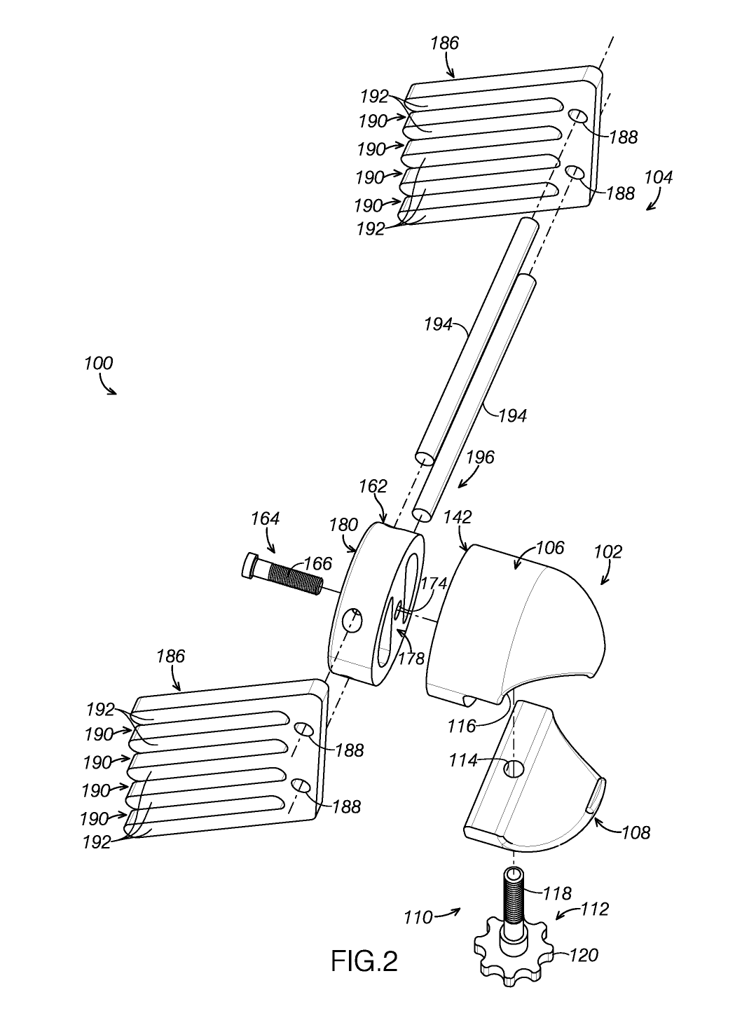

FIG. 2 shows an exploded view of equipment storage device 100, illustrating that clamp fastening member 112 is insertable into an outer surface of second clamp partner 108 and through an inner surface of second clamp partner 108 and first clamp partner 106. Therefore, insertion hole 114 is extended through second clamp partner 108, while insertion hole 116 is partially extended through first clamp partner 106. A threaded shaft 118 is complimentarily configured to and selectively insertable into insertion holes 114 and 116. A hand-grip 120 is provided at one end of shaft 118 for operation by a user to selectively move (e.g., turning clockwise and, alternatively, turning counter clockwise) threaded shaft 118 between a tightened position and a loosened position.

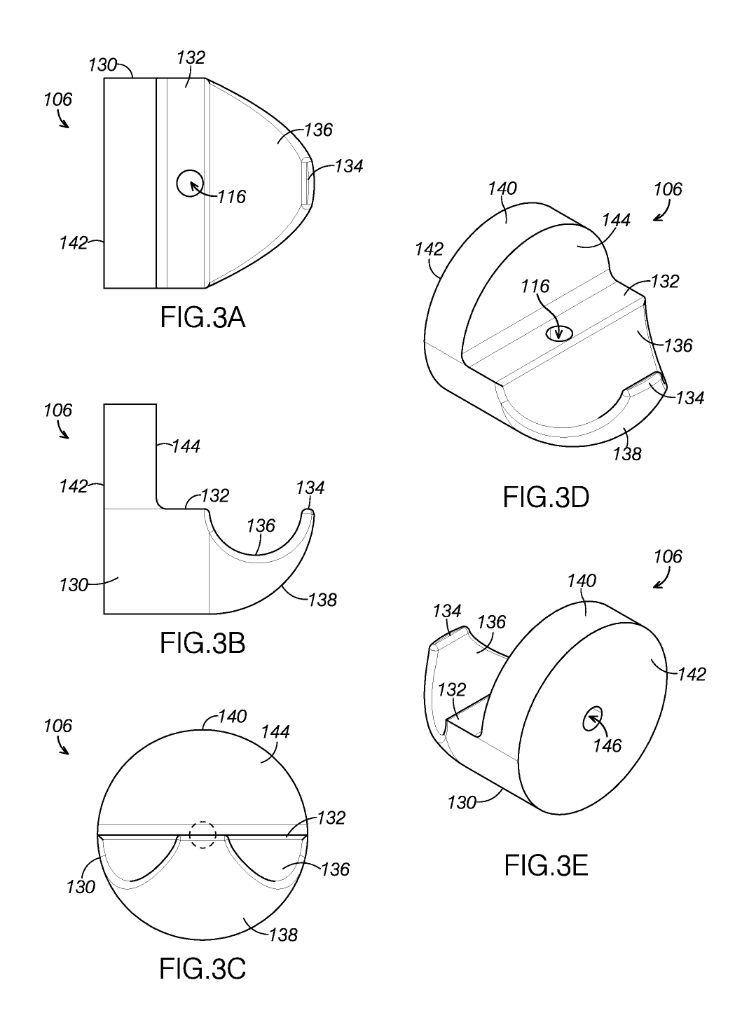

Detailed views of first clamp partner 106 are shown in FIGS. 3A-3E. A main body 130 of first clamp partner 106 includes a shelf 132, an outer lip 134, an arcuate inner surface 136, and an outer surface 138. In the present example, arcuate inner surface 136 is a continuously curving arc extended between shelf 132 and outer lip 136. Arcuate inner surface 136 is substantially tapered, being wider an intersection with shelf 132 (i.e., a location proximal to shelf 132) and narrower at an intersection with outer lip 134 (i.e. a location proximal to outer lip 134). In this example, outer surface 138 is substantially rounded to a similar shape as inner arcuate surface 136 (i.e., the outer surface being a convex compliment to the concave inner surface). Further, body 130 has a generally circular profile from front and rear views (as shown in FIGS. 3C and 3E).

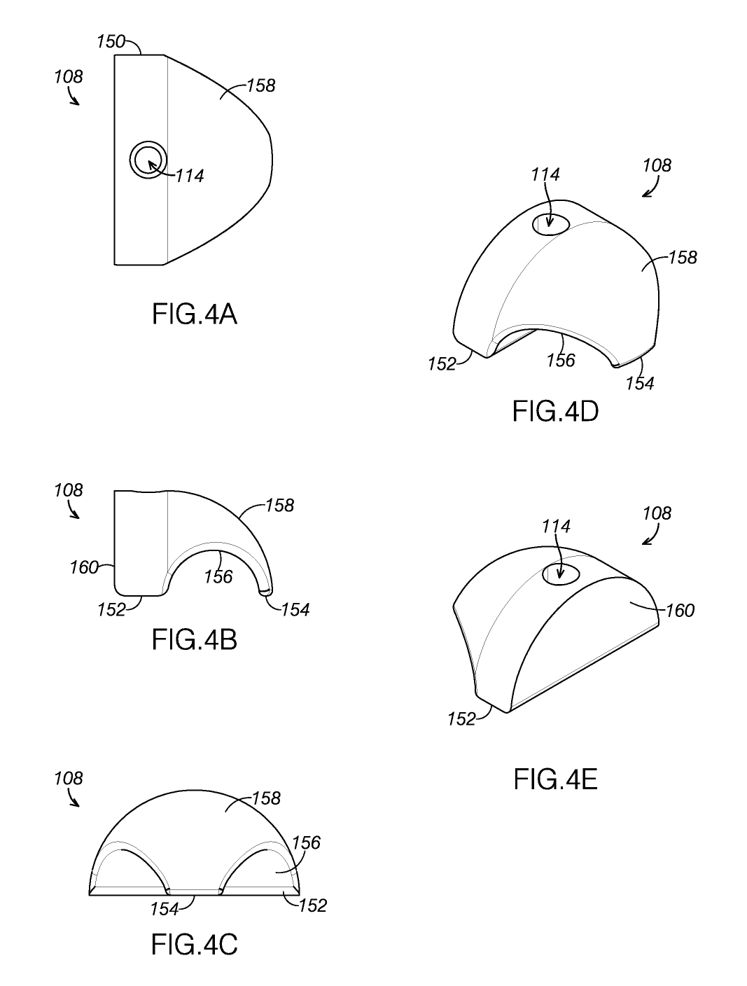

Detailed views of second clamp partner 108 are shown in FIGS. 4A-4E. A main body 150 of second clamp partner 108 includes a shelf 152, an outer lip 154, an arcuate inner surface 156, and an outer surface 158. In the present example, arcuate inner surface 156 is a continuously curving arc extended between shelf 152 and outer lip 156. Arcuate inner surface 156 is substantially tapered, being wider an intersection with shelf 152 (i.e., a location proximal to shelf 152) and narrower at an intersection with outer lip 154 (i.e. a location proximal to outer lip 154). In this example, outer surface 158 is substantially rounded to a similar shape as inner arcuate surface 156 (i.e., the outer surface being a convex compliment to the concave inner surface). Further, body 150 has a generally half-circular profile from front and rear views (as shown in FIGS. 4C and 4E).

Returning to FIGS. 3A-3E, first clamp partner 106 further includes an upward projection 140, a universal adapter-abutting wall 142 (including a centrally located longitudinal insertion hole 146), and a second clamp partner-abutting wall 144. When first clamp partner 106 and second clamp partner 108 are coupled, a first clamp partner-abutting wall 160 (shown in FIGS. 4A-4E) is configured to be abutted to second clamp partner-abutting wall 144 and second shelf 152 is configured to be abutted to first shelf 132. Accordingly, when coupled (as shown in FIG. 1) second clamp partner 106 (body 150) is substantially fitted into first clamp partner 106 (body 130). In the present example, the half-circular shape of body 130 is fitted into a space in body 150 so that the front and rear profile views (not specifically shown) substantially form a circular shape that is congruous with the circular front and rear profile views of body 150.

Further, as illustrated in FIG. 1, when first clamp partner 106 and second clamp partner 108 are coupled, inner arcuate surfaces 136 and 156 are configured to form a generally cylindrical rod-receiving space 148. Rod-receiving space 148 is configured to receive and/or retain a rod (e.g., a railing) (not specifically shown) of a boat as second clamp partner 108 is fitted into first clamp partner 106. Furthermore, inner arcuate surfaces 136 and 156 are configured to contact an outer surface of the rod.

Further still, first clamp partner 106 and second clamp partner 108 are configured to provide a pincer grip on the rod. Clamp coupling mechanism 110 can be selectively tightened to increase a pincer grip on the rod and selectively loosened to decrease a pincer grip on the rod. The rod can be released from rod-receiving space 148 by releasing coupling mechanism 110 (i.e., removing fastening member 112 from insertion holes 114 and 116) and removing second clamp partner 108 from first clamp partner 106.

Returning to FIGS. 2 and 3A-3E, universal adapter-abutting wall 142 of first clamp partner 106 is located on an opposing side of upward projection 140 relative to second clamp partner-abutting wall 144. As shown in FIGS. 1 and 2, a first example of a universal adapter, universal adapter 162, may be attached to first clamp partner 106 via a universal adapter attachment mechanism 164.

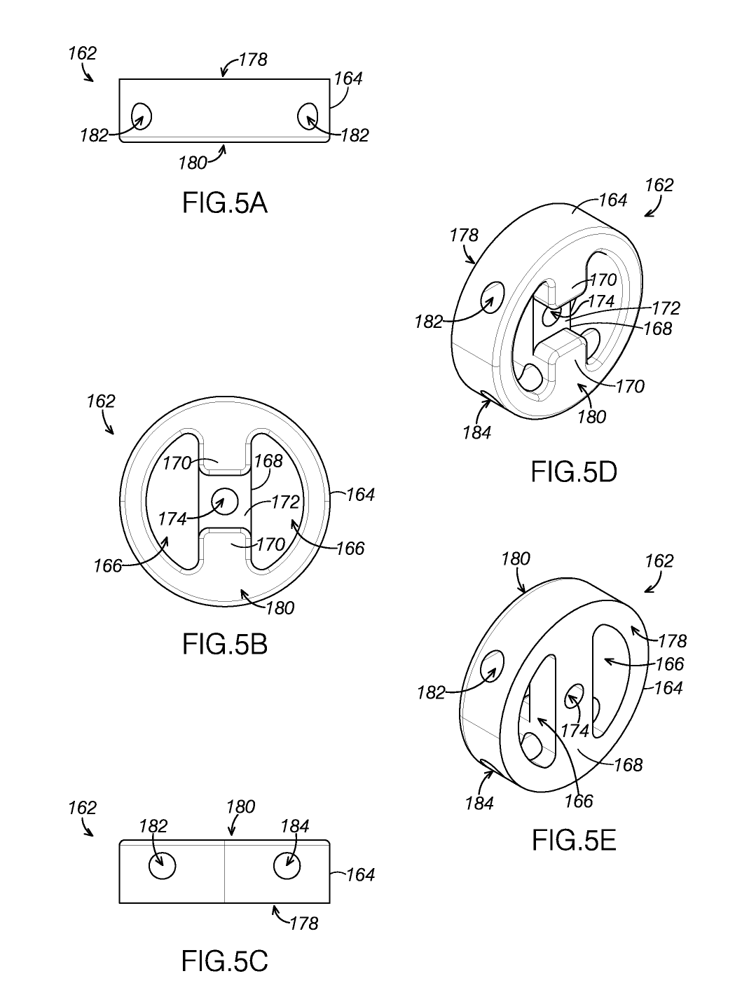

Detailed views of universal adapter 162 are shown in FIGS. 5A-5E. As depicted in FIGS. 5A-5E, universal adapter 162 has a generally disc-shaped body 164. Body 164 has generally circular front and rear profile views (shown in FIGS. 5B and 5E) that has substantially the same dimensions as body 150. Body 164 includes a pair of generally half-circular open spaces 166 that are bisected by a vertical cross bar 168.

Cross bar 168 is vertically extended through a center of body 164 (i.e., across a diameter of the circular disc shaped body). Cross bar 168 includes a pair of shoulders 170 that are extended from an outer periphery of body 164 to a depression region 172. The depth of cross bar 168 at depression region 172 is less than the depth of cross bar 168 at pair of shoulders 170. Cross bar 168 includes a longitudinal insertion hole 174, which is generally centrally located in depression region 172.

When attached to first clamp partner (as shown in FIGS. 1 and 2), a face 178 is a non-exposed face, and non-exposed face 178 is abutted to universal adapter-abutting wall 142. An exposed face 180 is on an opposing side of body 164 relative to non-exposed face 178. As shown in FIGS. 5D and 5E, non-exposed face 168 is generally a flat surface, while exposed face 180 is a generally flat surface with rounded edges and includes an indentation at a location of depression region 172.

As illustrated in FIGS. 2, 3C, and 3E, universal adapter attachment mechanism 164 includes insertion hole 146, insertion hole 174, and a fastening member 166. Fastening member 166 is selectively insertable through insertion hole 174 and into insertion hole 146 for attachment of universal connector 162 to first clamp partner 106.

In the present example, universal adapter fastening member 166 is a threaded fastening member and insertion holes 146 and 176 are complimentarily configured to receive the threaded fastening member. In alternate examples, the fastening member and the insertion holes may have some other complimentary configuration for attachment of the universal adapter to the first clamp member, such as a releasable snap-fit mechanism. In even other examples, the attachment mechanism may have some other configuration for attachment of the universal adapter to the first clamp partner, such as a pair of flanges that are slidably fit into a pair of grooves.

FIGS. 2 and 5A-5E show that universal adapter 162 further includes lateral insertion channels 182 and 184 for attachment of storage accessory 104 to the universal adapter. As described above, storage accessory 104 is configured to retain, store, and/or organize one or more trolling flashers.

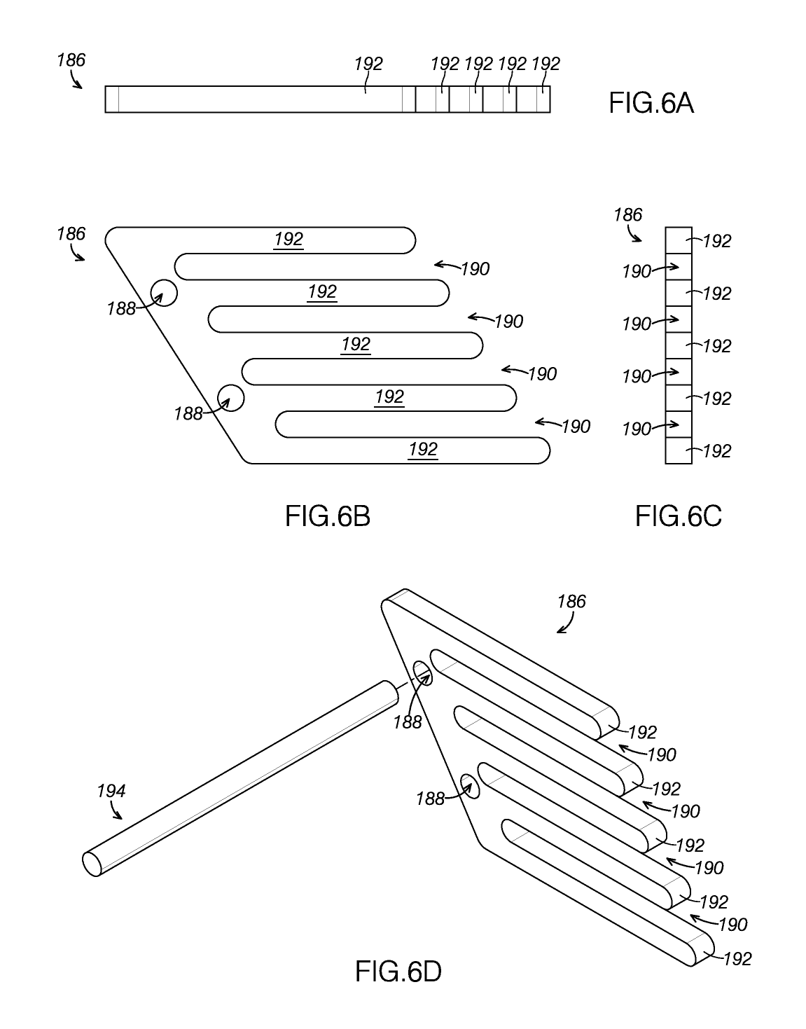

FIGS. 2 and 6A-6D show detailed views of storage accessory 104. Storage accessory 104 includes a pair of shelving walls 186 for cooperatively receiving one or more trolling flashers. Each of the shelving walls 186 has an identical configuration, including a plurality of elongate projections 192 and a plurality of flasher-receiving spaces 190 disposed between each of the adjacent elongate projections 192. Each of plurality of flasher-receiving spaces has an opening such that trolling flashers are insertable into the flasher-receiving spaces. The plurality of elongate projections may be covered in a compressible material (e.g., rubber, silicone, looped fabric, etc.) in order to provide friction slip resistance and cushioning during storage of trolling flashers in storage accessory 104.

Each of shelving walls 186 further includes a pair of lateral insertion holes 188 on an opposing side of the shelving wall relative to openings of flasher-receiving spaces 190. A pair of dowels 194 can be fitted into opposing insertion holes 188 (e.g., an upper insertion hole 188 in each of shelving walls 186 or a lower insertion hole in each of shelving walls 186). Further, dowels 194 are insertable into insertion channels 182 and 184 for attachment of shelving walls 186 to universal adapter 162. Thus, insertion holes 188, dowels 194, and insertion channels 182 and 184 substantially comprise an accessory attachment mechanism 196.

With reference to FIGS. 7-9D, a second example of an equipment storage device, equipment storage device 200, will now be described. Equipment storage device 200 includes rod clamping mechanism 102 (described in detail above) and a storage accessory 204. Equipment storage device 200 functions to releasably attach to a rod and/or hand railing of boat for retaining, storing, and/or organizing equipment. More specifically, because of the configuration of storage accessory 204 (described in detail below), equipment storage device 200 can be used to retain, store, and/or organize one or more ropes, fishing nets, flashlights, etc. Further, when used cooperatively with a second identical equipment storage device, storage device 200 can be used to retain, store, and/or organize one or more fishing rods.

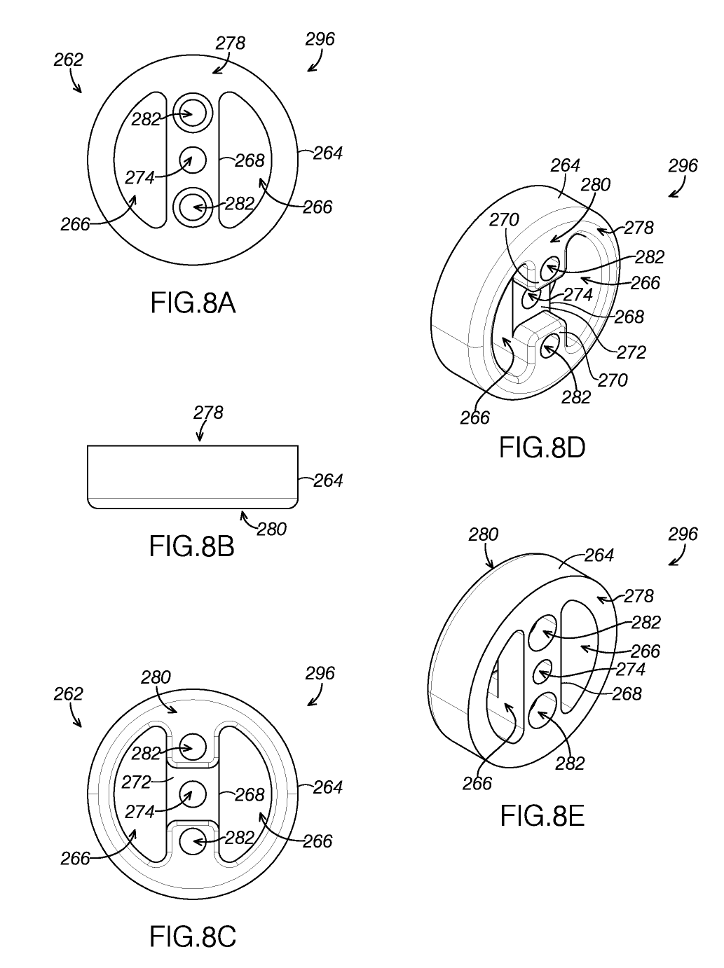

Alternatively to universal adapter 162 and storage accessory 104, a universal adapter 262 can be used to attach storage accessory device 204 to rod clamping mechanism 102. Detailed views of universal adapter 262 are shown in FIGS. 8A-8E. As depicted in FIGS. 8A-8E, universal adapter 262 has a generally disc-shaped body 264. Body 264 has generally circular front and rear profile views (shown in FIGS. 8A and 8B) that has substantially the same dimensions as body 150. Body 264 includes a pair of generally half-circular open spaces 266 that are bisected by a cross bar 268.

Cross bar 268 is vertically extended through a center of body 264 (i.e., across a diameter of the circular disc shaped body). Cross bar 268 includes a pair of shoulders 270 that are extended from an outer periphery of body 264 to a depression region 272. The depth of cross bar 268 at depression region 272 is less than the depth of cross bar 268 at pair of shoulders 270. Cross bar 168 includes an insertion hole 274, which is generally centrally located in depression region 272.

When attached to first clamp partner (as shown in FIG. 7), a face 278 is a non-exposed face, and non-exposed face 278 is abutted to universal adapter-abutting wall 142. An exposed face 280 is on an opposing side of body 264 relative to non-exposed face 278. As shown in FIGS. 8A and 8E, non-exposed face 268 is generally a flat surface, while exposed face 280 is a generally flat surface with rounded edges and includes an indentation at a location of depression region 272.

As illustrated in FIGS. 7, 3C, and 3E, universal adapter attachment mechanism 264 includes insertion hole 146, insertion hole 274, and a fastening member 166 (shown in FIG. 2). Fastening member 166 is selectively insertable through insertion hole 274 and into insertion hole 146 for attachment of universal connector 262 to first clamp partner 106.

In the present example, universal adapter fastening member 166 is a threaded fastening member and insertion holes 146 and 276 are complimentarily configured to receive the threaded fastening member. In alternate examples, the fastening member and the insertion holes may have some other complimentary configuration for attachment of the universal adapter to the first clamp member, such as a releasable snap-fit mechanism. In even other examples, the attachment mechanism may have some other configuration for attachment of the universal adapter to the first clamp partner, such as a pair of flanges that are slidably fit into a pair of grooves.

FIGS. 8A-8E show that universal adapter 262 further includes a pair of insertion holes 282 for attachment of storage accessory 204 to the universal adapter. Pair of insertion holes 282 are extended through shoulders 282 and located on either side of insertion hole 274. As described above, storage accessory 204 is configured to retain, store, and/or organize one or more pieces of equipment that can be hung on a hook (e.g., ropes, fishing nets, flashlights, fishing rods, etc).

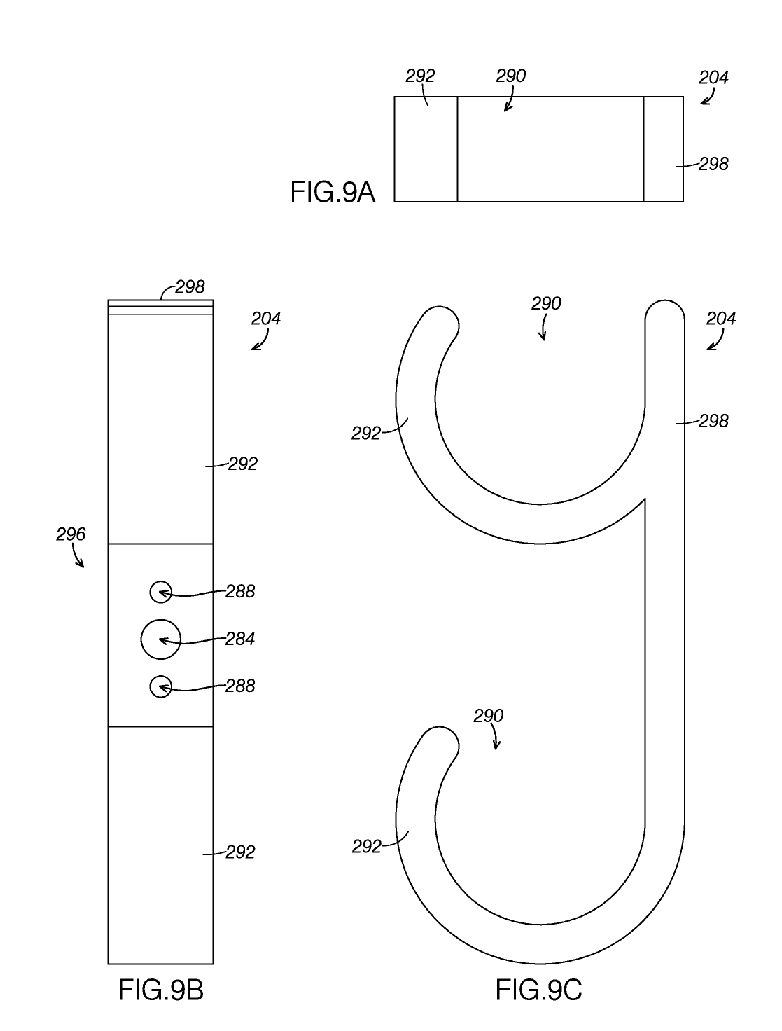

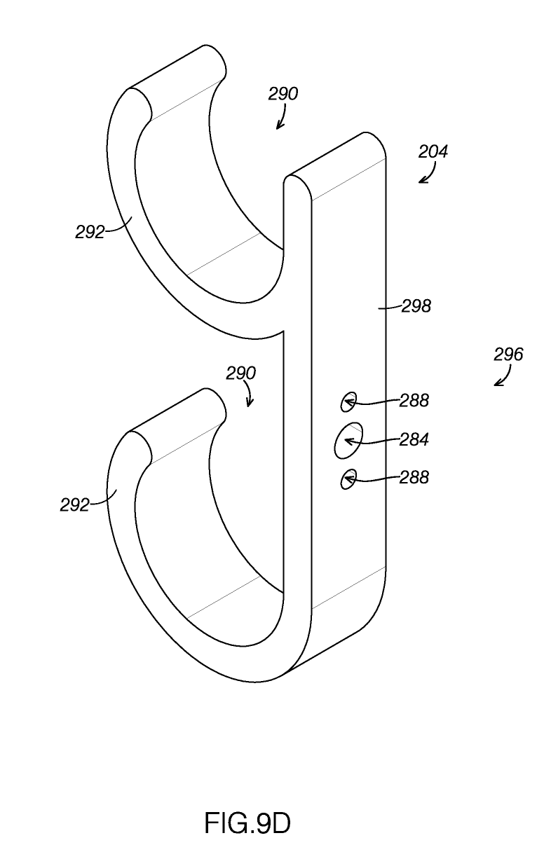

FIGS. 7 and 9A-9D show detailed views of storage accessory 204. Storage accessory 204 includes a pair of hooks 292 for receiving one or more pieces of equipment. Each of the pair of hooks 292 has an identical configuration, being a hook shaped projection extended away from a wall 298 with an opening 290 disposed within each hook. The hooks may be covered in a compressible material (e.g., rubber, silicone, looped fabric, etc.) in order to provide friction slip resistance and cushioning during storage of trolling flashers in storage accessory 204.

In the present example, wall 298 includes a centrally located insertion hole 284 with a pair of insertion holes 288 disposed on either side of insertion hole 284 (i.e., above and below insertion hole 284). In the example of FIGS. 7-9D, insertion hole 284 is alignable with insertion hole 274. A fastening member (not specifically shown) can be inserted through insertion hole 284 and 274 and further inserted into insertion hole 146. Thus, insertion holes 284, 274, and 146 and the fastening member substantially comprise an accessory attachment mechanism 296. Further, each of a pair of additional fastening members can be inserted through insertion holes 288 and into insertion holes 282. Thus, in the present example, accessory attachment mechanism 296 further includes insertion holes 288 and 282, and the pair of additional fastening members.

It will be appreciated that the fastening members for accessory attachment mechanism 296 may be threaded fastening members and insertion holes 284, 288, 282, and 274 may be complimentarily configured to the threaded fastening members. In alternate examples, the fastening member and the insertion holes may have some other complimentary configuration for attachment of the universal adapter to the first clamp member, such as a releasable snap-fit mechanism. In even other examples, the attachment mechanism may have some other configuration for attachment of the universal adapter to the first clamp partner, such as a pair of flanges that are slidably fit into a pair of grooves.

It will be appreciated that in alternate examples, a universal adapter can include both the features of universal adapter 162 and universal adapter 262. In this alternate example, the universal adapter would include a longitudinally extended insertion hole in each of the shoulders of the crossbar and also laterally extended insertion channels. As the this alternate example of a universal adapter includes attachment features for each of the above described accessory attachment mechanism, either of storage accessory 104 and storage accessory 204 can be selectively attached to the universal adapter.

Further, in additional alternate examples of equipment storage devices and/or equipment storage device systems, one or more storage devices may include various configurations for storage accessories. For example, a storage accessory may be configured as a flag pole holder, a bar-b-que mount, an tray, a fishing hook rack, a cub holder, a rope winding device, a fishing pole holder for retaining a fishing pole in an upright direction, a lock box, a light holder, etc.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A mounting clamp for selectively mounting accessory devices to a rod, comprising:
a first clamp partner having a first main body, the first main body having:
a first arcuate inner surface,
a first shelf, and
a first outer lip, the first arcuate inner surface being a first continuously curving arc extended from the first shelf to the first outer lip;
a second clamp partner having a second main body, the second main body having:
a second arcuate inner surface,
a second shelf, and
a second outer lip, the second arcuate inner surface being a continuously curving arc extended from the second shelf to the second outer lip;
a clamp coupling mechanism for coupling the second clamp partner to the first clamp partner;
a universal connector the universal connector being selectively attachable to the first clamp partner via a universal connector attachment mechanism; and
at least one storage accessory that is selectively attachable to the universal connector via an accessory attachment mechanism,
wherein the first clamp partner and the second clamp partner are configured to be selectively coupled together to form a generally cylindrical cavity, the generally cylindrical cavity configured to retain a rod, each of the first arcuate surface and the second arcuate surface making surface-to-surface contact with an outer surface of the rod.

2. The mounting clamp of claim 1, wherein the clamp coupling mechanism is selectively tightened to increase a pincer grip of the first clamp partner and the second clamp partner on the rod and selectively loosened to decrease a pincer grip of the first clamp partner on the rod.

3. The mounting clamp of claim 1, wherein the first clamp partner further comprises a universal connector-abutting face, the universal connector-abutting face being generally perpendicular relative to the first shelf on an opposing side of the first shelf relative to the first arcuate inner surface, the universal connector having an exposed face and a non-exposed face, the exposed face the universal connector-abutting face being abutted to the non-exposed face when the universal connector is attached to the first clamp partner.

4. The mounting clamp of claim 3, wherein the universal connector attachment mechanism comprises a universal connector fastening member, a first insertion hole in a center of the universal adapter-abutting face, and a second insertion hole in a center of the universal adapter, and
the universal connector fastening member is selectively insertable into the first and the second insertion holes for releasable attachment of the universal connector to first clamp partner.

5. The mounting clamp of claim 1, wherein the first inner arcuate surface is generally tapered and wider at an intersection between the first shelf and the first inner arcuate surface and narrower at an intersection between the first outer lip and the first inner arcuate surface.

6. The mounting clamp of claim 1, wherein the second inner arcuate surface is generally tapered and wider at an intersection between the second shelf and the second inner arcuate surface and narrower at an intersection between the second outer lip and the second inner arcuate surface.

7. The mounting clamp of claim 1, wherein the universal connector has a generally disc-shaped body.

8. The mounting clamp of claim 1, where in the clamp coupling mechanism comprises a first insertion hole disposed within the first main body having a first opening in the first shelf, a second insertion hole disposed within the second main body and having a second opening in the second shelf and a third opening on an outer surface of the second main body, the outer surface being on an opposing side of the second main body relative to the second shelf, and a clamp fastening member, the clamp fastening member being selectively insertable through the third, the second, and the third insertion holes for coupling the first clamp partner to the second clamp partner, the first shelf being abutted to the second shelf when the first clamp partner is coupled to the second clamp partner.

9. The mounting clamp of claim 1, wherein at least one storage accessory comprises at least one of an accessory configured to retain trolling flashers, an accessory configured to retain fishing poles, an accessory configured to retain fishing hooks, an accessory configured to retail a flag pole, an accessory configured to retain a cup, an accessory configured to retain a bar-b-que, an accessory configured to retain a tray, an accessory configured to retain rope, an accessory configured to retain a lockbox, and an accessory configured to retain a light.

10. A mounting clamp for selectively mounting a storage accessory to a rod, comprising:
a first clamp partner having a first body and a first rod-abutting face;
a second clamp partner having a second body and a second rod-abutting face;
a coupling mechanism for coupling the first clamp partner to the second clamp partner; and
a universal connector having a universal connector attachment mechanism, the universal connector being attachable to the first clamp partner via the universal connector attachment mechanism,
wherein the first clamp partner and the second clamp partner are configured to be selectively coupled together to retain a rod, each of the first rod-abutting face and the second rod-abutting face making surface-to-surface contact with an outer surface of the rod, and
wherein at least one accessory device is attachable to the universal connector via a storage accessory attachment mechanism.

11. The mounting clamp of claim 10, wherein the first rod-abutting face is a first arcuate inner surface and the second rod-abutting face is a second arcuate inner surface, and the first arcuate inner surface and the second arcuate inner surface form a generally cylindrical cavity when the first clamp partner is coupled to the second clamp partner, the generally cylindrical cavity configured to receive the rod.

12. The mounting clamp of claim 10, wherein the first body comprises the first rod-abutting face, a first shelf, a first outer lip, and a universal connector-abutting face, the first rod-abutting face being a continuously curving arc extended from the first shelf to the first lip.

13. The mounting clamp of claim 12, wherein the first continuously curving arc is generally tapered and wider at an intersection between the first shelf and the first continuously curving arc and narrower at an intersection between the first outer lip and the first continuously curving arc.

14. The mounting clamp of claim 10, wherein the second body comprises the second rod-abutting face, a second shelf, and a second outer lip, the second rod-abutting face being a second continuously curving arc extended from the second shelf to the second lip.

15. The mounting clamp of claim 14, wherein the second continuously curving arc is generally tapered and wider at an intersection between the second shelf and the second continuously curving arc and narrower at an intersection between the second outer lip and the second continuously curving arc.

16. The mounting clamp of claim 10, wherein the coupling mechanism comprises a first insertion hole in the first body, a second insertion hole in the second body, and a clamp fastening member, the clamp fastening member being selectively insertable through the first and the second insertion holes for coupling the first clamp partner to the second clamp partner.

17. The mounting clamp of claim 16, wherein the clamp fastening member is selectively tightened to increase a pincer grip of the first clamp partner and the second clamp partner around the rod and selectively loosened to decrease a pincer grip of the first clamp partner and the second clamp partner around the rod.

18. The mounting clamp of claim 10, wherein the universal connector attachment mechanism comprises an universal connector fastening member, a first insertion hole in a center of the universal adapter-abutting face, and a second insertion hole in a center of the universal adapter, and
the universal connector fastening member is selectively insertable into the first and the second insertion holes for releasable attachment of the universal connector to first clamp partner.

19. A mounting clamp system for selectively mounting a storage accessory to a rod, comprising:
a first clamp partner having a first main body, the first main body having:
a first arcuate inner surface,
a first shelf,
a first outer lip, the first arcuate inner surface being a first continuously curving arc extended from the first shelf to the first outer lip, and
a first insertion hole disposed within the first main body and having a first opening in the first shelf,
a universal connector abutting face, the universal connector abutting face being generally perpendicular relative to the first shelf on an opposing side of the first shelf relative to the first arcuate inner surface and the first outer lip;
a second clamp partner having a second main body, the second main body having:
a second arcuate inner surface,
a second shelf,
a second outer lip, the second arcuate inner surface being a continuously curving arc extended from the second shelf to the outer second lip, and
a second insertion hole disposed within the second main body and having a second opening in the second shelf and a third opening on an outer surface of the second main body, the outer surface being on an opposing side of the second main body relative to the second shelf;
a clamp fastening member, the clamp fastening member being selectively insertable through the third, the second, and the first insertion holes for coupling the second clamp partner to the first clamp partner;
a universal connector having an exposed face and a non-exposed face, the universal connector being selectively attachable to the first clamp body via a universal connector attachment mechanism so that the non-exposed face is abutted to the universal connector-abutting face, the universal connector further having an accessory attachment mechanism; and
one or more storage accessories, one of the one or more storage accessories releasably attached to the universal connector via the accessory attachment mechanism,
wherein the first clamp partner and the second clamp partner are configured to be selectively coupled together to form a generally cylindrical cavity, the generally cylindrical cavity configured to retain a rod, each of the first arcuate inner surface and the second arcuate inner surface making surface-to-surface contact with an outer surface of the rod, and
wherein the clamp fastening member is selectively tightened to increase a pincer grip of the first clamp partner and the second clamp partner around the rod and selectively loosened to decrease a pincer grip of the first clamp partner around the rod.

20. The mounting clamp system of claim 19, wherein the one or more storage accessories comprises one or more of an accessory configured to retain trolling flashers, an accessory configured to retain fishing poles, an accessory configured to retain fishing hooks, an accessory configured to retail a flag pole, an accessory configured to retain a cup, an accessory configured to retain a bar-b-que, an accessory configured to retain a tray, an accessory configured to retain rope, an accessory configured to retain a lockbox, and an accessory configured to retain a light.
